(19) United States
(12) Patent Application Publication
(10) Pub. No.: US 2025/0260276 A1
(43) Pub. Date: Aug. 14, 2025

(54) ELECTRIC MOTOR

(71) Applicant: AAC Microtech (Changzhou) Co., Ltd., Changzhou (CN)

(72) Inventors: Lubin Mao, Changzhou (CN); Wei Song, Changzhou (CN); Xiujiang Si, Changzhou (CN)

(21) Appl. No.: 18/748,062

(22) Filed: Jun. 19, 2024

Related U.S. Application Data
(63) Continuation of application No. PCT/CN2024/076865, filed on Feb. 8, 2024.

(51) Int. Cl. H02K 1/24; H02K 1/2713; H02K 5/04

(52) U.S. Cl. CPC H02K 1/243; H02K 1/2713; H02K 5/04

(57) ABSTRACT

The present application provides a motor, including a plurality of first limit grooves spaced apart on a plastic member, and a second limit groove arranged between two adjacent first limit grooves. A plurality of first claw fingers in the first claw pole are connected to the first claw disk, which are embedded in the corresponding first limit grooves. A plurality of second claw fingers in the second claw pole are connected to the second claw disk, which are embedded in the corresponding second limit grooves, so that the first and second claw poles can be integrally injected, the strength of the claw poles is effectively improved and the assembly precision of the stator is ensured. Moreover, the size of the coil can be effectively increased, thereby achieving the technical effect of improving the assembly precision of the electric motor and increasing the torque of the product.

### CROSS-REFERENCE TO RELATED APPLICATIONS

This application is a continuation of International Application No. PCT/CN2024/076865, filed on Feb. 8, 2024, the entire contents of which are incorporated herein by reference.

### TECHNICAL FIELD

The present application relates to the technical field of electric motors, in particular to an electric motor.

### BACKGROUND

The electric motor is an electromagnetic device that converts or transfers electrical energy, mainly composed of a stator and a rotor. As a special type of electric motor, a stepper motor belongs to an electric motor used for control. It is an electric motor that converts electrical pulse signals into corresponding angular displacement or linear displacement.

In the related art, the electric motors typically employ two claw poles arranged on a skeleton separately, with the coil wound on the skeleton and then assembled with the claw poles. However, by winding the coil on the skeleton and then assembling it with the claw pole arrange on the skeleton, an internal space enclosed by the two claw poles is small, which reduces the thickness of the claw poles and lowers the strength of the claw pole lower, making it difficult to ensure the mounting accuracy of the stator. Besides, it reduces the number of turns of the coil, which is not conducive to improving the torque of the product.

Therefore, it is necessary to provide a new technical solution to solve the above technical problems.

### SUMMARY

An object of the present application is to provide an electric motor that can solve the problem of the prior art that is unfavorable to improving the driving performance of the electric motor.

The technical solution of the present application is as follows. An electric motor comprises:
a first claw pole comprising a first claw disk and a plurality of first claw fingers;
a second claw pole comprising a second claw disk and a plurality of second claw fingers; and
a plastic member, the plastic member being provided with a plurality of first limit grooves arranged at intervals and second limit grooves provided between two adjacent the first limit grooves;
wherein the plurality of the first claw fingers are connected to the first claw disk, and each of the first claw fingers is embedded in a corresponding first limit groove; the plurality of the second claw fingers are connected to the second claw disk, and each of the second claw fingers is embedded in a corresponding second limit groove; and each of the second claw fingers is provided between two adjacent the first claw fingers.

In one embodiment, the plastic member comprises a first limit portion and a second limit portion that are arranged opposite to each other, and a casing connecting the first limit portion and the second limit portion; wherein a plurality of support members are arranged between the first limit portion and the second limit portion; two adjacent the support members and the first limit portion enclose to form one of the first limit groove, and two adjacent the support members and the second limit portion enclose to form one of the second limit groove.

In one embodiment, the first limit portion, the support members, and the casing enclose to form a first through groove for penetration of the first claw finger, and the first through groove is in communication with the first limit grooves; the second limit portion, the support members, and the casing enclose to form a second through groove for penetration of the second claw finger, and the second through groove is in communication with the second limit grooves.

In one embodiment, the casing comprises a body and two extension portions connected to the body; the body is connected to the first limit portion and the second limit portion, and the body and the two extension portions enclose to form a mounting groove for accommodating a coil.

In one embodiment, the electric motor further comprises a rotating shaft and a magnetic steel connected to the rotating shaft; the rotating shaft is arranged through the casing, and the magnetic steel is located between the rotating shaft and the support member.

In one embodiment, a projection of the first limit portion along a lengthwise direction of the rotating shaft is located on one of the extension portions, and the first claw disk is connected to one of the extension portions; a projection of the second limit portion along the lengthwise direction of the rotating shaft is located on the other of the extension portions, and the second claw disk is connected to the other of the extension portions.

In one embodiment, the first claw finger comprises a first finger root portion and a first fingertip portion connected to the first finger root portion; the first finger root portion is connected to the first claw disk, and the first fingertip portion is recessed in a direction toward the rotating shaft; the second claw finger comprises a second finger root portion and a second fingertip portion connected to the second finger root portion; the second finger root portion is connected to the second claw disk, and the second fingertip portion is recessed in a direction toward the rotating shaft; and the second fingertip portion and the first fingertip portion are enclosed in a circular shape.

In one embodiment, a spacing between the first finger root portion and the rotating shaft is widened in a direction toward the first claw disk, and a spacing between the second finger root portion and the rotating shaft is widened in a direction toward the second claw disk.

In one embodiment, extension lines of the two adjacent support members intersect.

In one embodiment, the first claw finger is tapered in a direction toward the second claw disk, the second claw finger is tapered in a direction toward the first claw disk, and the first claw pole and the second claw pole are each integrally injection molded.

The beneficial effect of the present application is as follows. In the electric motor provided by the present application, a plurality of first limit grooves are spaced apart on a plastic member and a second limit groove between two adjacent first limit grooves. A plurality of first claw fingers in the first claw pole are connected to the first claw disk, and each of the first claw fingers is embedded in a corresponding first limit groove. A plurality of second claw fingers in the second claw pole are connected to the second claw disk, and each of the second claw fingers is embedded in a corresponding second limit groove and provided between two adjacent first claw fingers. In this way, the plurality of first claw fingers in the first claw pole are embedded in the corresponding first limit groove on the plastic member, and the plurality of second claw fingers in the second claw pole are embedded in the corresponding second limit groove on the plastic member, which enables the first claw pole and the second claw pole to be integrally injected, effectively improves the strength of the claw pole and is conducive to ensuring the assembly precision of the stator. Moreover, the size of the coil can be effectively increased when winding the coil with the first claw pole and the second claw pole, which is conducive to increasing the torque of the product, thereby achieving the technical effect of improving the assembly precision of the electric motor and increasing the torque of the product.

### BRIEF DESCRIPTION OF THE DRAWINGS

FIG. 1 shows a structural schematic diagram of a first claw pole, a second claw pole, and a first plastic member in a motor according to an embodiment of the present application.

FIG. 2 shows a structural schematic diagram of a rotating shaft in the motor according to an embodiment of the present application.

FIG. 3 shows an exploded view of the motor according to an embodiment of the present application.

FIG. 4 shows a structural schematic diagram of the motor according to an embodiment of the present application.

FIG. 5 shows a cross-sectional view of the motor according to an embodiment of the present application.

FIG. 6 shows a structural schematic diagram of first limit grooves, second limit grooves, and a first through groove in the motor according to an embodiment of the present application.

FIG. 7 shows a structural schematic diagram of a second through groove in the motor according to an embodiment of the present application.

FIG. 8 shows a structural schematic diagram of a first claw disk and a second claw disk in the motor according to an embodiment of the present application.

FIG. 9 shows a structural schematic diagram of a first finger root portion and a first fingertip portion in the motor according to an embodiment of the present application.

### DETAILED DESCRIPTION OF THE EMBODIMENTS

Embodiments of the present application are described in detail below, and examples of the embodiments are shown in the accompanying drawings, in which the same or similar symbols throughout denote the same or similar elements or elements having the same or similar functions. The embodiments described below by reference to the accompanying drawings are exemplary and are intended to be used only for the purpose of explaining the present application and are not to be construed as a limitation of the present application.

In order to enable those skilled in the art to better understand the embodiments of the present application, the technical solutions in the embodiments of the present application will be clearly and completely described below in conjunction with the accompanying drawings in the embodiments of the present application. Obviously, the described embodiments are only a part of the embodiments of the present application rather than not all of the embodiments. Based on the embodiments in this application, all other embodiments obtained by those skilled in the art without making creative labor fall within the protection scope of the present application.

In the embodiments of the present application, at least one means one or more; more than one, means two or more than two. In the description of the present application, the terms “first”, “second”, “third”, etc., are used only for the purpose of distinguishing the description, and are not to be understood as indicating or implying relative importance, nor are they to be understood to indicate or imply order.

References to “an embodiment” or “a number of embodiments” and the like in this specification mean that one or more embodiments of the present application including a particular feature, structure, or characteristic described in conjunction with that embodiment. Thus, in this specification, the terms “include”, “comprise”, “have”, and variations thereof, mean “include but not limited to” unless otherwise specifically emphasized. It should be noted that, in the embodiments of the present application, “and/or” describes an associative relationship of the associated objects, indicating that three kinds of relationships may exist, for example, A and/or B, which may indicate the three cases of the existence of A alone, the existence of both A and B, and the existence of B alone.

It should be noted that in embodiments of the present application, when a component is “fixed to” another component, it may be directly on the other component or there may be a centered component. When a component is “attached” to another component, it may be directly attached to the other component or there may be both centered components. When a component is considered to be “set on” another component, it may be set directly on the other component or there may be both centered components. Moreover, in this embodiment, “connect” may be understood as an electrical connection, and the connection of two electrical components may be a direct or indirect connection between two electrical components. For example, the connection between A and B may be either a direct connection between A and B or an indirect connection between A and B through one or more other electrical components. The terms “vertical”, “horizontal”, “left”, “right” and the like are used in the embodiments of the present application for illustrative purposes only and are not intended to limit the present application.

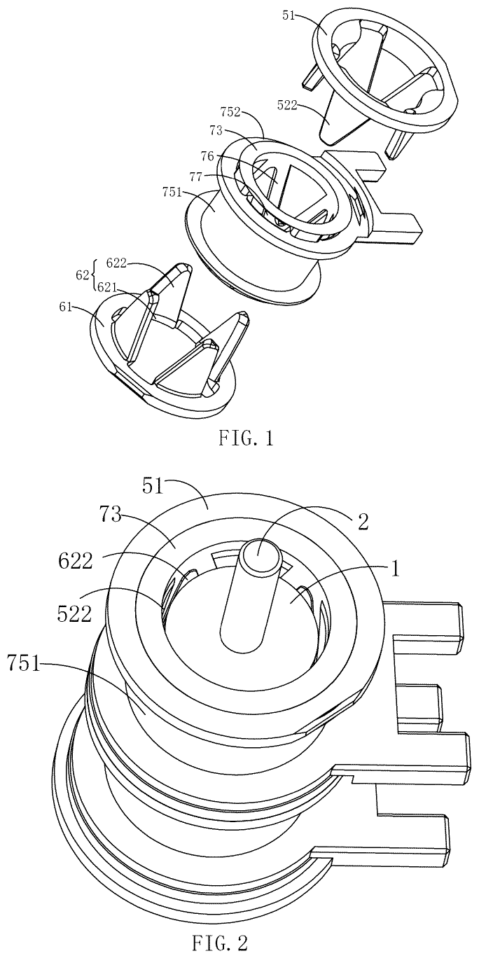

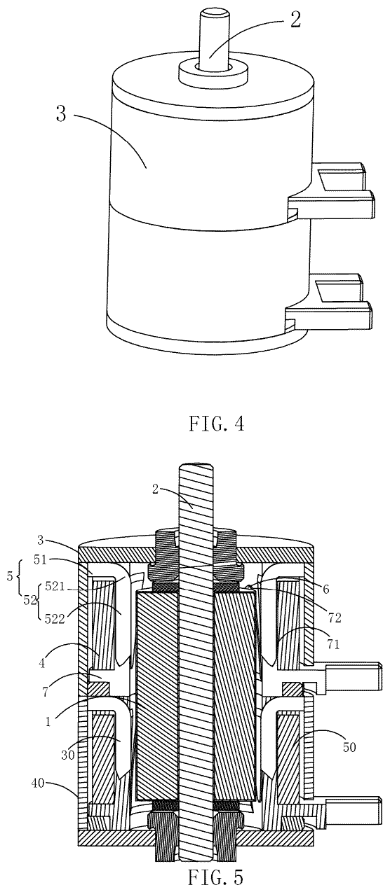

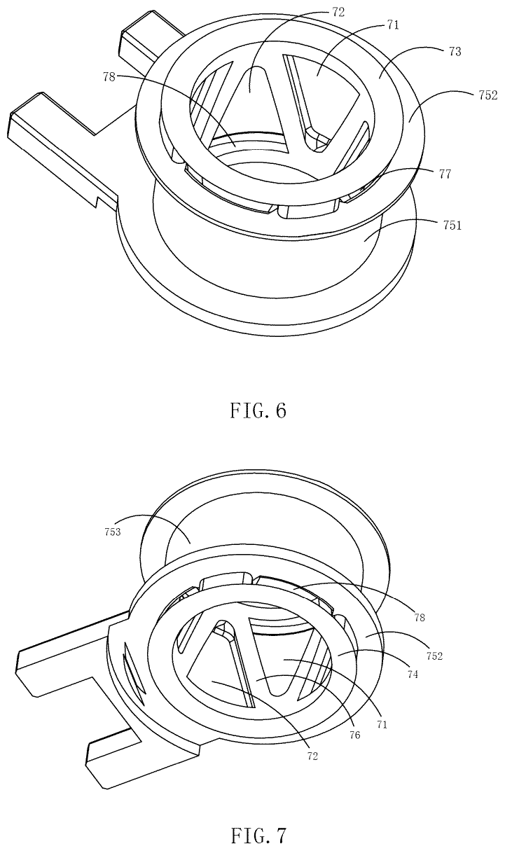

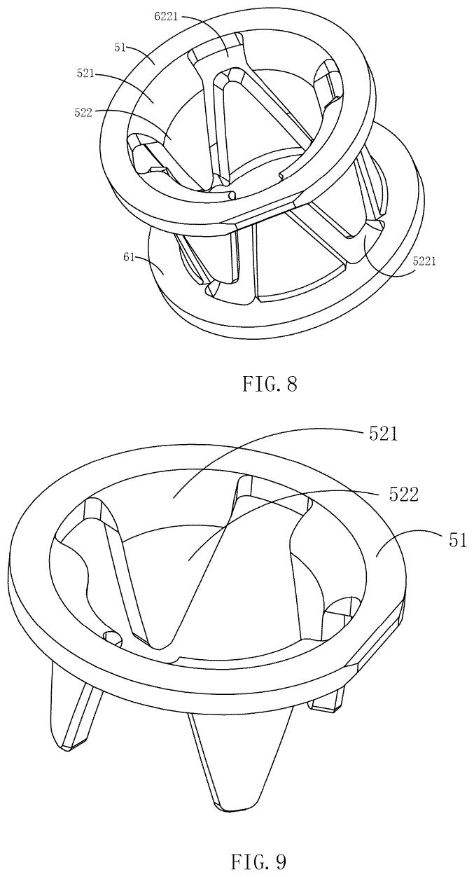

As shown in FIGS. 1 to 9, an embodiment of the present application provides a motor, including a first claw pole 5, a second claw pole 6, and a plastic member 7. The plastic member 7 is provided with a plurality of spaced-apart first limit grooves 71, and a second limit groove 72 is provided between two adjacent first limit grooves 71. The first claw pole 5 includes a first claw disk 51 and a plurality of first claw fingers 52. The plurality of first claw fingers 52 are connected to the first claw disk 51, and each of the first claw fingers 52 is embedded in a corresponding first limit groove 71. The second claw pole 6 includes a second claw disk 61 and a plurality of second claw fingers 62. The plurality of second claw fingers 62 are connected to the second claw disk 61, and each of the second claw fingers 62 is embedded in a corresponding second limit groove 72 and provided between the two adjacent first claw fingers 52, i.e., the first claw fingers 52 and the second claw fingers 62 are alternately distributed along the exterior of the rotating shaft 2.

The plastic member 7 is provided outside the rotating shaft 2, and the magnetic steel 1 is located between the rotating shaft 2 and the plastic member 7. The plastic member 7 includes the first limit grooves 71 and the second limit grooves 72. A plurality of the first limit grooves 71 are spaced apart from each other, and each of the second limit grooves 72 is provided between two adjacent first limit grooves 71. The first claw pole 5 includes a first claw disk 51 and a plurality of first claw fingers 52. The plurality of first claw fingers 52 are connected to the first claw disk 51, and each of the first claw fingers 52 is embedded in a corresponding first limit groove 71. The first limit grooves 71 have a space to accommodate the first claw fingers 52. The second claw pole 6 includes a second claw disk 61 and a plurality of second claw fingers 62. The plurality of second claw fingers 62 are connected to the second claw disk 61, each of the second claw fingers 62 is embedded in a corresponding second limit groove 72, and the second limit grooves 72 have a space to accommodate the second claw fingers 62.

In this embodiment, a plurality of first limit grooves 71 are spaced apart on the plastic member 7, and second limit grooves 72 are arranged between two adjacent first limit grooves 71. A plurality of first claw fingers 52 in the first claw pole 5 are connected to the first claw disk 51, and each of the first claw fingers 52 is embedded in a corresponding first limit groove 71. A plurality of second claw fingers 62 in the second claw pole 6 are connected to the second claw disk 61, and each of the second claw fingers 62 is arranged between two adjacent first claw fingers 52. In this way, the plurality of first claw fingers 52 in the first claw pole 5 are embedded in the corresponding first limit groove 71 on the plastic member 7, and the plurality of second claw fingers 62 in the second claw pole 6 are embedded in the corresponding second limit groove 72 on the plastic member 7, which enables the first claw pole 5 and the second claw pole 6 to be integrally injected, effectively improves the strength of the claw pole and is conducive to ensuring the assembly precision of the stator. Moreover, the size of the coil 4 can be effectively increased when winding the coil 4 with the first claw pole 5 and the second claw pole 6, which is conducive to increasing the torque of the product, thereby achieving the technical effect of improving the assembly precision of the electric motor and increasing the torque of the product.

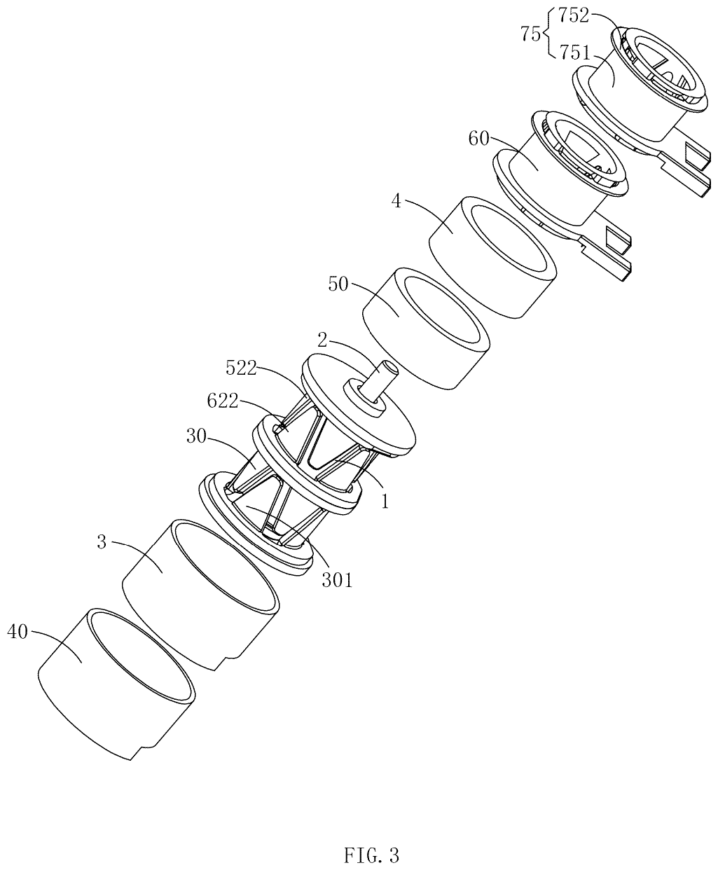

As an embodiment, as shown in FIGS. 1 and 2, the plastic member 7 includes a first limit portion 73, a second limit portion 74, and a casing 75. The first limit portion 73 and the second limit portion 74 are arranged relative to each other, and the casing 75 is connected to the first limit portion 73 and the second limit portion 74. A plurality of support members 76 are arranged between the first limit portion 73 and the second limit portion 74. The first limit portion 73 and the two adjacent support members 76 enclose to form the above-described first limit grooves 71, and the second limit portion 74 and the two adjacent support members 76 enclose to form the above-described second limit grooves 72.

As an embodiment, the first limit portion 73, the support members 76 and the casing 75 enclose to form a first through groove 77, and the first claw fingers 52 are arranged through the first through groove 77. The first through groove 77 is in communication with the first limit grooves 71, such that the first claw fingers 52 pass through the first through groove 77 and then extend into the first limit grooves 71. The second limit portion 74, the support members 76, and the casing 75 enclose to form a second through groove 78, and the second claw fingers 62 are arranged through the second through groove 78. The second through groove 78 is in communication with the second limit grooves 72, such that the second claw fingers 62 pass through the second through groove 78 and then extend into the second limit grooves 72.

As an embodiment, as shown in FIG. 3, the casing 75 includes a body 751 and two extension portions 752. The two extension portions 752 are both connected to the body 751, and the body 751 is connected to the first limit portion 73 and the second limit portion 74. The body 751 and the two extension portions 752 enclose to form a mounting groove 753, and the interior of the mounting groove 753 has a space for accommodating a coil 4.

In some embodiments, a projection of the first limit portion 73 along a lengthwise extension of the rotating shaft 2 is located on one of the extension portions 752, and the first claw disk 51 is connected to one of the extension portions 752. A projection of the second limit portion 74 along the lengthwise direction of the rotating shaft 2 is located on the other of the extension portions 752, and the second claw disk 61 is connected to the other of the extension portions 752.

In some embodiments, the coil 4 can be wound integrally with the first claw pole 5 and the second claw pole 6 after the first claw pole 5 and the second claw pole 6 are integrally injection molded. The first claw fingers 52 are tapered in a direction toward the second claw disk 61, and the second claw fingers 62 are tapered in a direction toward the first claw disk 51.

In some embodiments, as shown in FIGS. 2 to 9, each first claw finger 52 includes a first finger root portion 521 and a first fingertip portion 522. The first fingertip portion 522 is connected to the first finger root portion 521, the first finger root portion 521 is connected to the first claw disk 51, and the first fingertip portion 522 is recessed in a direction toward the rotating shaft 2. Each second claw finger 62 includes a second finger root portion 621 and a second fingertip portion 622. The second fingertip portion 622 is connected to the second finger root portion 621, the second finger root portion 621 is connected to the second claw disk 61, the second fingertip portion 622 is recessed in a direction toward the rotating shaft 2. The second fingertip portions 622 and the first fingertip portions 522 are enclosed in a circular shape, which is able to increase the inner space of the circular shape, thereby providing a larger space for accommodating the rotating shaft 2 and the magnet steel 1 arranged in a circumferential direction around the rotating shaft 2.

As an embodiment, the spacing between the first finger root portion 521 and the rotating shaft 2 is gradually widened in a direction toward the first claw disk 51, such that the first finger root portion 521 is presented as a curved shape. The spacing between the second finger root portion 621 and the rotating shaft 2 is gradually widened in a direction toward the second claw disk 61, such that the second finger root portion 621 is presented as a curved shape.

As an embodiment, a first gap 5221 is left between the first fingertip portion 522 and the second claw disk 61, and a second gap 6221 is left between the second fingertip portion 622 and the first claw disk 51, with the spacing of the first gap 5221 and the spacing of the second gap 6221 being equal, such that the joints of the two adjacent support members 76 arranged within the spacing are of greater width.

In some embodiments, extension lines of the two support members 76 arranged on both sides of the first claw finger 52 cross each other, and it is beneficial to improve the strength of the overall structure of the first claw pole 5, the second claw pole 6, the plastic member 7, and the support members 76 by providing the support members 76 that cross each other.

As an embodiment, as shown in FIGS. 3 to 5, the motor provided by embodiments of the present application further includes a casing 3. It can be understood by the technical personnel in the field that there is no restriction on the specific structure of the casing 3 in the electric motor provided by the embodiments of the present application. It is only necessary to place the plastic member 7 with the coil 4, the first claw pole 5, and the second claw pole 6 in the interior of the casing 3, and place the rotating shaft 2 and the magnetic steel 1 sleeved around the rotating shaft 2 in the interior of the casing 3, so that the rotating shaft 2 and the magnetic steel 1 arranged around the rotating shaft 2 are driven to rotate in the interior of the casing 3 by the energized coil 4.

In some embodiments, as shown in FIG. 3, the motor provided by embodiments of the present application further includes a third claw pole 30, a fourth claw pole 301, another casing 40, another coil 50, and another plastic member 60. The third claw pole 30 and the above-described first claw pole 5 have the same structure and principle, so they are not repeated herein. The fourth claw pole 301 and the above-mentioned second claw pole 6 have the same structure and principle, so they are not repeated herein. Another casing 40 and the above-mentioned casing 3 have the same structure and principle, so they are not repeated herein. Another coil 50 and the above-mentioned coil 4 have the same structure and principle, so they are not repeated herein. Another plastic member 60 and the above-mentioned plastic member 7 have the same structure and principle, so they are not repeated herein. The third claw pole 30 and the fourth claw pole 301 are mounted to another plastic member 60, another coil 50 is mounted to the outside of another plastic member 60, another casing 40 is sleeved to the outside of another coil 50, and the plastic member 7 and the other plastic member 60 are arranged in a vertical direction, it is possible to accommodate a longer rotating shaft 2 as well as a longer magnet 1 arranged around the rotating shaft 2

As an embodiment, the magnet steel 1 in the motor provided by embodiments of the present application is a one-piece magnetic steel 1, i.e., the magnetic steel 1 presented as a cylinder is sleeved on the rotating shaft 2, the rotating shaft 2 is fixedly connected to the magnetic steel 1, and both ends of the rotating shaft 2 extends out of the magnetic steel 1.

Described above are only some embodiments of the present application, and it should be pointed out herein that, for the person of ordinary skill in the field, improvements may be made without departing from the inventive concept of the present application, but these are all within the protection scope of the present application.

What is claimed is:

1. An electric motor, comprising:
a first claw pole comprising a first claw disk and a plurality of first claw fingers;
a second claw pole comprising a second claw disk and a plurality of second claw fingers; and
a plastic member, the plastic member being provided with a plurality of first limit grooves arranged at intervals and second limit grooves provided between two adjacent the first limit grooves;
wherein the plurality of the first claw fingers are connected to the first claw disk, and each of the first claw fingers is embedded in a corresponding first limit groove; the plurality of the second claw fingers are connected to the second claw disk, and each of the second claw fingers is embedded in a corresponding second limit groove; and each of the second claw fingers is provided between two adjacent the first claw fingers.

2. The electric motor of claim 1, wherein the plastic member comprises a first limit portion and a second limit portion that are arranged opposite to each other, and a casing connecting the first limit portion and the second limit portion; wherein a plurality of support members are arranged between the first limit portion and the second limit portion; two adjacent the support members and the first limit portion enclose to form one of the first limit grooves, and two adjacent the support members and the second limit portion enclose to form one of the second limit grooves.

3. The electric motor of claim 2, wherein the first limit portion, the support members, and the casing enclose to form a first through groove for penetration of the first claw fingers, and the first through groove is in communication with the first limit grooves; the second limit portion, the support members, and the casing enclose to form a second through groove for penetration of the second claw fingers, and the second through groove is in communication with the second limit grooves.

4. The electric motor of claim 2, wherein the casing comprises a body and two extension portions connected to the body; the body is connected to the first limit portion and the second limit portion, and the body and the two extension portions enclose to form a mounting groove for accommodating a coil.

5. The electric motor of claim 2, further comprising a rotating shaft and a magnetic steel connected to the rotating shaft; the rotating shaft is arranged through the casing, and the magnetic steel is located between the rotating shaft and the support member.

6. The electric motor of claim 5, wherein a projection of the first limit portion along a lengthwise direction of the rotating shaft is located on one of the extension portions, and the first claw disk is connected to one of the extension portions; a projection of the second limit portion along the lengthwise direction of the rotating shaft is located on the other of the extension portions, and the second claw disk is connected to the other of the extension portions.

7. The electric motor of claim 5, wherein each of the first claw fingers comprises a first finger root portion and a first fingertip portion connected to the first finger root portion; the first finger root portion is connected to the first claw disk, and the first fingertip portion is recessed in a direction toward the rotating shaft; each of the second claw fingers comprises a second finger root portion and a second fingertip portion connected to the second finger root portion; the second finger root portion is connected to the second claw disk, and the second fingertip portion is recessed in a direction toward the rotating shaft; and the second fingertip portion and the first fingertip portion are enclosed in a circular shape.

8. The electric motor of claim 7, wherein a spacing between the first finger root portion and the rotating shaft is widened in a direction toward the first claw disk, and a spacing between the second finger root portion and the rotating shaft is widened in a direction toward the second claw disk.

9. The electric motor of claim 2, wherein extension lines of the two adjacent support members intersect.

10. The electric motor of claim 1, wherein the first claw fingers are tapered in a direction toward the second claw disk, the second claw fingers are tapered in a direction toward the first claw disk, and the first claw pole and the second claw pole are each integrally injection molded.
